(19) United States
(12) Patent Application Publication
(10) Pub. No.: US 2022/0019348 A1
(43) Pub. Date: Jan. 20, 2022

(54) TOUCH INTERFACE DEVICE AND CONTROL METHOD

(71) Applicant: Tae Ho KANG, Seongnam-si (KR)

(72) Inventor: Tae Ho KANG, Seongnam-si (KR)

(21) Appl. No.: 17/311,337

(22) PCT Filed: Dec. 6, 2018
(86) PCT No.: PCT/KR2018/015369

§ 371 Date: Jun. 6, 2021

(51) Int. Cl. G06F 3/0488; G06F 3/041; H04L 12/28; G06K 9/00; H04W 4/80

(52) U.S. Cl. CPC G06F 3/04886; G06F 3/0412; H04L 12/2827; H04L 12/282; H04L 2012/2841; H04W 4/80; G06F 2203/04803; G06F 2203/04105; G06K 9/00087

(57) ABSTRACT

The present invention relates to a touch interface device comprising: a touch recognition unit for recognizing a figure drawn by a touch on a touch screen; and a control unit for generating, on the basis of attribute information including the shape and size of each of figures recognized via the touch recognition unit and relative position information between the respective figures, a control signal corresponding to the attribute information and the relative position information.

### TECHNICAL FIELD

The present disclosure relates to a touch interface device.

### BACKGROUND ART

Today, electronic systems such as TVs, smartphones, laptop computers, and tablets are equipped with various input/output devices.

Various input/output devices are provided to allow users to conveniently control the above systems.

The above systems have different control methods (usages). Accordingly, they cause inconvenience to users because the users are required to learn individual control methods for the respective systems to use the systems.

For example, each of a TV, an air conditioner, and so on has its own remote controller and the usage differs among the respective remote controllers, which causes inconvenience by requiring the users to learn how to use each remote controller individually.

Further, efforts should be put forth for maintenance and management such as battery replacement of each of these remote controllers.

Such electronic systems also require the user to go through several steps to execute an application having a specific function, thereby causing inconvenience.

For example, to play music on a smartphone, a user needs to take several steps including turning on the smartphone, executing a music playback application through personal authentication, and playing desired music. Accordingly usability is degraded due to complicated execution steps for the music playback application.

Electronic systems have different personal authentication methods. For this reason, the user must learn the personal authentication method for each system.

Authentication through a password or password pattern and biometric authentication are representative methods for personal authentication.

When a password or password pattern is used as a personal authentication method, the user needs to know the password or password pattern, which is intended to enhance security, for each system.

However, when there are excessively many passwords or password patterns or there are many passwords or password patterns that are not frequently used, the user may forget the password or password pattern or remember an incorrect password or password pattern, thereby having difficulty in using the systems.

In addition, when personal authentication is performed on a smartphone by a password or password pattern, a keypad for inputting the password or password pattern is displayed at a specific location on a smartphone screen in advance.

However, since the keypad for inputting the password or the password pattern is displayed at a specific location on the screen of the smartphone, an operation of entering the password or the password pattern by a user may be revealed. As a result, not only personal information about the user but also the user's personal life may be revealed.

To use biometric authentication as a personal authentication method, biometric authentication information about the user needs to be pre-stored in electronic systems.

However, when electronic systems storing the biometric authentication information about the user are exposed to hacking or the like, there is a risk that the biometric authentication information about the user is revealed against intention of the user.

### DISCLOSURE

### Technical Problem

Therefore, the present disclosure has been made in view of the above problems, and it is one object of the present disclosure to provide a touch interface device for generating a corresponding control signal based on attribute information of figures drawn on a touchscreen and information about relative positions of the figures.

It is another object of the present disclosure to provide a touch interface device for dividing, when a figure drawn on the touchscreen is the partition figure including a line or a surface, a space on a touchscreen into a plurality of spaces depending on the shape of a line or surface of a partition figure and generating a control signal depending on the position of a figure drawn before or after the partition figure is drawn.

The objects to be achieved by the present disclosure are not limited to the above-mentioned objects, and other objects not mentioned can be clearly understood by those skilled in the art from the following description.

### Technical Solution

In accordance with one aspect of the present disclosure, provided is a touch interface device including a touch recognition unit configured to recognize a figure touched and drawn on a touchscreen, and a controller configured to generate a corresponding control signal based on attribute information including a shape and a size of each figure recognized through the touch recognition unit and relative position information about figures, wherein, when the recognized figure is a partition figure including a line or a surface, the controller divides a space on the touchscreen into a plurality of spaces depending on a shape of the line or the surface and generates a control signal corresponding to a position of a figure, which is drawn before or after the partition figure is drawn, in the plurality of spaces.

In accordance with another aspect of the present disclosure, provided is a method of controlling a touch interface device, including recognizing a figure touched and drawn on a touchscreen, by a touch recognition unit, and generating a corresponding control signal based on attribute information including a shape and a size of each figure recognized through the touch recognition unit and relative position information about figures, by a controller, wherein the generating the control signal includes, when the recognized figure is a partition figure including a line or a surface, dividing a space on the touchscreen into a plurality of spaces depending on a shape of the line or the surface, and generating a control signal corresponding to a position of a figure, which is drawn before or after the partition figure is drawn, in the plurality of spaces.

### Advantageous Effects

As described above, according to the present disclosure, various control signals may be generated depending on the shapes and dimensions of two or more figures drawn on a touchscreen, and relative positions of the figures.

According to the present disclosure, the touch interface device may be connected to various locking devices and may enhance security through various patterns, not a constant pattern.

The effects obtainable in the present disclosure are not limited to the above-mentioned effects, and other effects not mentioned herein will be clearly understood by those skilled in the art from the following description.

### DESCRIPTION OF DRAWINGS

FIG. 1 is a diagram showing the configuration of a touch interface device according to an embodiment of the present disclosure.

FIGS. 2 to 7 are diagrams showing examples in which various figures are sequentially drawn on a touchscreen according to an embodiment of the present disclosure.

FIG. 8 is a diagram showing an example in which a figure drawn on a touchscreen according to an embodiment of the present disclosure corresponds to information on a number.

FIGS. 9 and 10 are diagrams showing examples in which user fingerprint information is recognized during a procedure of drawing a figure on a touchscreen according to an embodiment of the present disclosure.

FIG. 11 is a diagram showing an example in which a wireless communication unit according to an embodiment of the present disclosure changes a communication method depending on a device for receiving a control signal and transmits the control signal.

FIG. 12A is a diagram showing an example in which a control signal is transmitted to various external devices through a hub external device for functioning as a hub according to an embodiment of the present disclosure.

FIG. 12B is a diagram showing an example in which FIG. 12A is actually applied.

FIG. 13 is a flowchart showing an example of a control method of a touch interface according to an embodiment of the present disclosure.

### BEST MODE

The advantages and features of the present invention and the manner of achieving the same will become apparent from the embodiments described in detail below with reference to the accompanying drawings. The present invention may, however, be embodied in many different forms and should not be construed as limited to the embodiments set forth herein. It should be understood that these embodiments are provided such that the disclosure will be thorough and complete, and will fully convey the concept of the invention to those skilled in the art. The scope of the invention is only defined by the claims.

Terms used in this specification are merely adopted to explain specific embodiments, and are not intended to limit the present invention. A singular expression encompasses a plural expression unless the two expressions are contextually different from each other. In this specification, “comprises” and/or “comprising” does not exclude presence or addition of one or more other elements in addition to the stated element. Throughout the specification, the same reference numerals refer to the same elements, and “and/or” includes each and all combinations of one or more of the mentioned elements. Although “first”, “second”, and the like are used to describe various elements, it would be obvious that these elements are not limited by these terms. These terms are only used to distinguish one component from another component. Therefore, it would be obvious that the first component mentioned below may be the second component within the technical idea of the present disclosure.

Unless otherwise defined, all terms (including technical and scientific terms) used herein have the same meaning as commonly understood by one of ordinary skill in the art to which this present disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the attached drawings.

Prior to the description, the meanings of terms used in the present specification will be briefly described. However, it should be noted that the description of terms is not intended to limit the technical idea of the present disclosure unless explicitly described as limiting the present disclosure because it is intended to aid in understanding of the present specification.

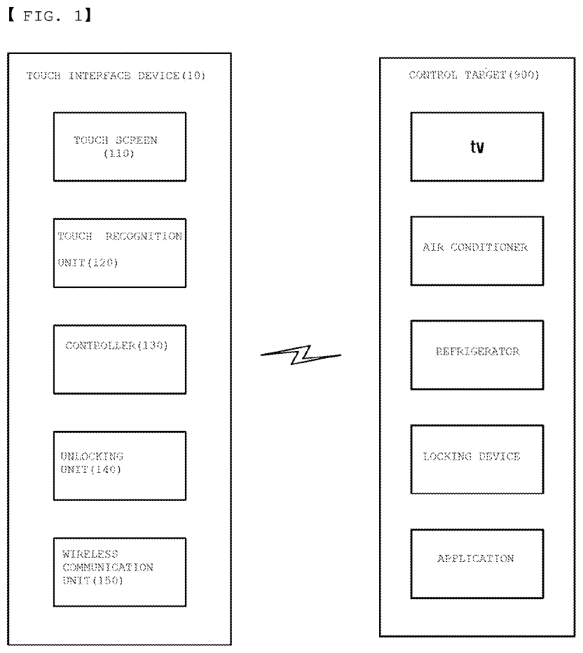

FIG. 1 is a diagram showing the configuration of a touch interface device 10 according to an embodiment of the present disclosure.

However, in some embodiments, the touch interface device 10 may include greater or fewer components than in FIG. 1.

Referring to FIG. 1, the touch interface device 10 according to an embodiment of the present disclosure may include a touchscreen 110, a touch recognition unit 120, a controller 130, an unlocking unit 140, and a wireless communication unit 150.

The touchscreen 110 may receive touch input from a user and refers to simultaneously displaying information on a screen and receiving touch input, such as a recent smartphone or tablet PC. For example, the touchscreen 110 may be a touch pad, a touch panel, or a touchscreen manufactured by adding a touch panel to a display.

The touch recognition unit 120 may recognize a figure drawn by touching the same on the touchscreen 110.

Based on attribute information including the shape and size of each figure recognized through the touch recognition unit 120 and relative position information about the figures, the controller 130 may generate a corresponding control signal.

The controller 130 may generate a control signal corresponding to input order information about figures along with the aforementioned information.

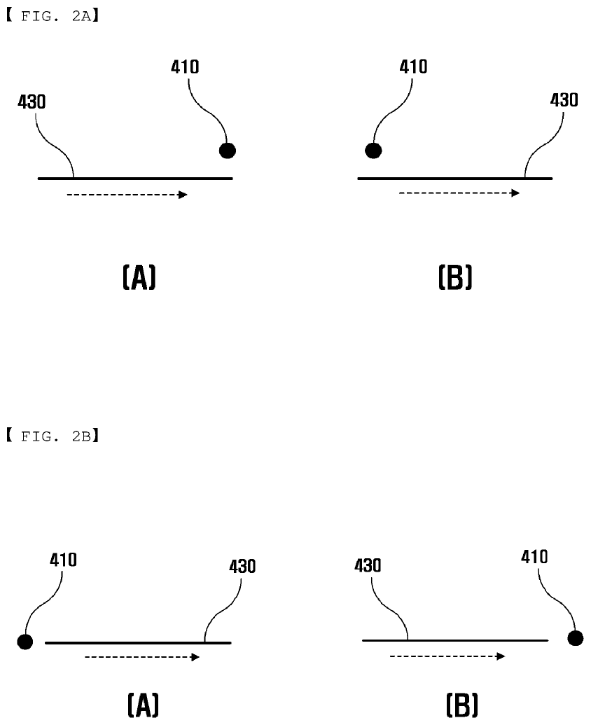

Accordingly, as shown in FIG. 2A, in the case where a horizontal line 430 is first drawn and then a point 410 is drawn and the case where the point 410 is first drawn and then the horizontal line 430 is drawn, the same control signal (which does not include input order information) may be generated, or different control signals (which include input order information) may be generated.

This may allow a user who implements the present disclosure to easily select the order depending on the cases.

Although the input order information is described as being included in some embodiments described below, this is only an example for describing the present disclosure and the present disclosure is not limited thereto.

In addition, when a recognized figure is a partition figure including a line or a surface, the controller 130 may divide a space on the touchscreen 110 into a plurality of spaces depending on the shape of the line or the surface and may generate a control signal corresponding to the position of a figure, which is drawn before or after the partition figures are drawn, in the plurality of spaces.

According to an embodiment of the present disclosure, a figure may mean a shape including a point, a line, and a plane.

Based on attribute information including the shape and size of two or more figures drawn on the touchscreen 110 by a user, relative position information that means relative positions of the two or more figures, a sequence of input of each figure, and input order information that means temporal precedence, the controller 130 may generate a corresponding control signal.

Therefore, different control signals may be generated depending on the sizes and shapes of input drawn figures, a positional relationship between the figures, and the order in which the figures are drawn.

When at least one of the recognized figures is a partition figure including a line or a surface, the controller 130 may divide the space on the touchscreen 110 into a plurality of spaces depending on the shape of the line or the surface.

For example, when the partition figure includes a horizontal line, the touchscreen 110 may divide the space on the touchscreen 110 into upper, lower, left, and right parts based on the horizontal line.

In this case, when the figure includes a horizontal line, this may not mean that the figure is divided into upper and lower parts only based on the horizontal line and may mean that the figure is also divided into left and right of the horizontal line, and as such, a division range is not limited depending on the shape of a figure.

For example, when the figure is a straight line, the figure may be divided into left, right, upper, front, and rear parts, etc. based on a proceeding direction to an end point from a start point.

For example, the figure may be divided into a plurality of regions in various ways, and for example, the figure may be divided into left and right parts based on the center of the horizontal line, or the figure may be divided into three regions including a left part of a left end of the horizontal line, upper and lower parts of the horizontal line, and a right part of a right end of the horizontal line.

When the start and end points of the partition figure correspond to a figure, the controller 130 may also generate a control signal depending on whether a figure drawn before or after the partition figure is drawn is positioned adjacent to the start point of the partition figure or is positioned adjacent to the end point.

When the partition figure includes a closed curve, the controller 130 may divide the touchscreen 110 into the inside and outside of the partition figure.

As such, when the partition figure includes a closed curve, the controller 130 may divide a space of the touchscreen 110 into the inside and outside of the closed curve.

Depending on the position of a figure, which is drawn before or after the above partition figure is drawn, in the plurality of divided spaces, the controller 130 may generate a corresponding control signal.

Detailed examples thereof will be described in more detail with reference to other accompanying drawings.

As such, the controller 130 may generate a corresponding control signal depending on the number of various cases and may transmit the control signal to a control target 900 through the wireless communication unit 150 to control the control target 900 such as a TV, an air conditioner, a refrigerator, a locking device, or an application.

In this case, the control target 900 may be an external device connected to the touch interface device 10 using a wireless communication method, such as a TV, an air conditioner, a refrigerator, or a locking device.

The touch interface device 10 may be provided with a device such as a smartphone, a tablet PC, or a laptop computer, and thus may also control operations of various applications installed in the corresponding device.

As such, the touch interface device 10 may also control operations of various applications, and thus may be set for the operations of the various applications to perform each operation, and for example, may perform a task such as authentication or account transfer in a bank application.

According to an embodiment of the present disclosure, the attribute information may include at least one of information on a direction from a first touched point to an end point when each figure is drawn, information on the thickness of a touch line for drawing each figure, information on pressure intensity of the touch line, information on touch acceleration, information on the number of broken points of the figure, or information on a time interval at which figures are input.

In more detail, even if a first figure and a second figure are touched and drawn on the touchscreen 110, and attribute information, relative position information, and input order information are all the same, if even any one of information on the thickness of the touch line on which the first figure is drawn, information on pressure intensity of the touch line on which the first figure is drawn, and the touch acceleration of the touch line when the first figure is drawn is different, the cases in which the first figure and the second figure are drawn may be determined to be different, and different control signals may be generated.

For example, the case where two circles are continuously drawn at a first pressure and the case where the two circles are continuously drawn at a second pressure may be recognized to be different, and different control signals may be generated.

The relative position information may include the number of intersections at which two or more figures overlap.

In this case, the relative position information may further include information on a ratio by which the two or more figures overlap, a distance between the two or more figures, and a crossing angle of the two or more figures.

FIGS. 2 to 7 are diagrams showing examples in which various figures are sequentially drawn on the touchscreen 110 according to an embodiment of the present disclosure.

FIGS. 2 to 7 shows examples in which a control signal is changed in various ways depending on a method of drawing various figures on the touchscreen 110.

The following embodiments are described for explaining the present disclosure and are only some of possible implementations, and thus the present disclosure is not limited thereto.

FIGS. 2A, 2B, and 2C show examples in which the horizontal line 430 and the point 410 are drawn on the touchscreen 110.

(A) of FIG. 2A shows an example in which the horizontal line 430 is drawn in a right direction and the point 410 is drawn in an upper right part of the horizontal line 430.

(B) of FIG. 2A shows an example in which the horizontal line 430 is drawn in a right direction and the point 410 is drawn in an upper left part of the horizontal line 430.

Here, the cases have the same attribute information including the shape and size of figures and have the same input order information about the figures, but have different relative position information about the figures, as described above, and accordingly, different control signals may be generated in (A) and (B) of FIG. 2A.

Needless to say, differently from (A) of FIG. 2A, when the horizontal line 430 is drawn in a right direction and the point 410 is drawn in a lower right part of the horizontal line 430, another different control signal from in (A) of FIG. 2A may be generated.

To illustrate the practical application of this, a control signal for turning up the volume may be generated in the case of (A) of FIG. 2A. When the point 410 is drawn in a lower right of the horizontal line 430, a control signal for turning down the volume may be generated.

As shown in (B) of FIG. 2A, when the point 410 is drawn in an upper left part of the horizontal line 430, a control signal for turning up a channel of a TV may be generated, and when the point 410 is drawn in a lower left part of the horizontal line 430, a control signal for turning down may be generated.

Although FIG. 2A illustrates the case where the horizontal line 430 is drawn from left to right, another control signal for the case where the horizontal line 430 is drawn from right to left may also be generated (which includes information on a direction to an end point from a first touched start point when the figure is drawn).

In another example, depending on the length of the horizontal line 430, a control signal may be changed, and depending on information on the thickness of a touch line for drawing the horizontal line 430, information on pressure intensity of the touch line, or information on touch acceleration of the touch line, the control signal may be changed.

In another example, the control signal may be changed depending on information on a time interval between the time at which the horizontal line 430 is drawn and the time at which the point 410 is drawn. For example, in the case where the point 410 is drawn immediately after the horizontal line 430 is drawn and the case where an interval between the time at which the horizontal line 430 is drawn and the time at which the point 410 is drawn is 0.5 seconds, different control signals may be generated.

As described above for the case where a partition figure is included, the horizontal line 430 divides the touchscreen 110 into a plurality of regions, the controller 130 may divide a space on the touchscreen 110 into a plurality of regions based on the horizontal line 430 and may generate a control signal corresponding to the position of the point 410 drawn in each region.

An example thereof is shown in FIG. 2B.

(A) of FIG. 2B illustrates the case where the point 410 is drawn to the left of the horizontal line 430, and (B) of FIG. 2B illustrates the case where the point 410 is drawn to the right of the horizontal line 430.

As such, the controller 130 may divide the space into a plurality of regions using various methods, and for example, may divide the space into upper and lower parts based on the horizontal line 430 or may divide the space into left and right parts based on the horizontal line 430, and accordingly, different control signals may be generated in (A) and (B) of FIG. 2B.

(A) of FIG. 2C shows an example in which the point 410 is drawn above the middle of the horizontal line 430. (B) of FIG. 2C shows an example in which the point 410 is drawn below the middle of the horizontal line 430.

As described above, the controller 130 may divide the space on the touchscreen 110 into a plurality of regions based on the horizontal line 430.

In this case, assuming that the controller 130 divides the space into two upper and lower regions based on the horizontal line 430, different control signals may be generated in (A) and (B) of FIG. 2C.

However, assuming that the controller 130 divides the space into two left and right regions based on the horizontal line 430, the same control signal may be generated in (A) and (B) of FIG. 2C.

As such, according to the present disclosure, when a figure recognized by the controller 130 is a partition figure including a line or a surface, the controller 30 may divide the space on the touchscreen into a plurality of spaces depending on the shape of the line or the surface, but this may be applied in various ways depending on a division reference.

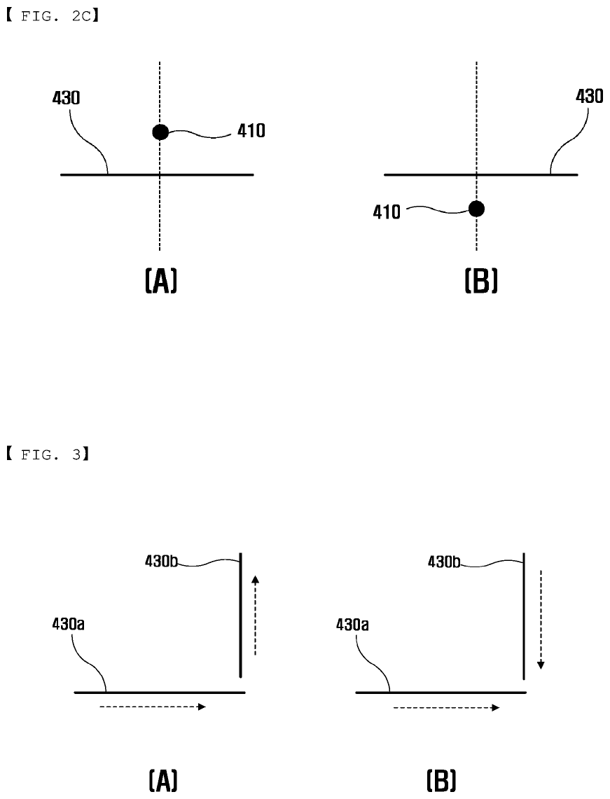

FIGS. 3 and 4 illustrate examples in which lines are drawn on the touchscreen 110.

(A) of FIG. 3 illustrates an example in which a horizontal line 430a is drawn in a right direction and a vertical line 430b is drawn upwards in an upper right part of the horizontal line 430a.

(B) of FIG. 3 illustrates an example in which the horizontal line 430a is drawn in a rightward direction and the vertical line 430b is vertically drawn on the upper right side of the horizontal line 430a.

To illustrate the practical application of this, the volume of a music application connected to the touch interface device 10 may be turned up as shown in (A) of FIG. 3, and the volume of the music application may be turned down as shown in (B) of FIG. 3.

In another example, when the horizontal line 430a is drawn in a rightward direction and the vertical line 430b is drawn downwards in an upper left part of the horizontal line 430a, a music application may skip to the next song, and when the horizontal line 430a is drawn in a rightward direction and the vertical line 430b is drawn upwards in an upper left part of the horizontal line 430a, the music application may skip to the previous song

As shown in FIG. 4, when the vertical line 430b is drawn in an upper left part based on the horizontal line 430a but is drawn downwards or upwards, different control signals may be generated.

In another example, when the horizontal line 430a is generated in a left direction, another different control signal may be generated.

As described with reference to FIG. 2, a control signal may also be changed depending on the lengths of the horizontal line 430a and the vertical line 430b, information on the thickness of a touch line, information on pressure intensity thereof, or information on touch acceleration thereof.

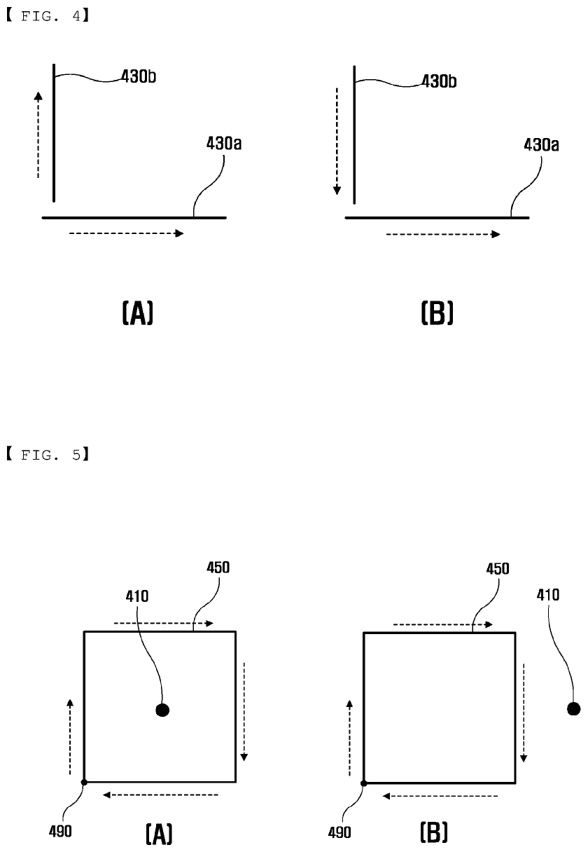

FIG. 5 illustrates an example in which a rectangle and a point are drawn on the touchscreen 110.

Based on attribute information including the shape and size of each of a rectangle 450 and the point 410, recognized through the touch recognition unit 120, relative position information about the rectangle 450 and the point 410, and input order information about the rectangle 450 and the point 410, the controller 130 may generate a corresponding control signal.

The rectangle 450 among the recognized figures is a partition figure including a surface, and thus a space on the touchscreen 110 may be divided into a plurality of spaces based on the rectangle 450.

In FIG. 5, the controller 130 may divide the space on the touchscreen 110 into the inside and the outside of the rectangle 450.

Depending on the position of the point 410, which is drawn before or after the partition figure (rectangle) is drawn, in the divided spaces, the controller 130 may generate a control signal.

(A) of FIG. 5 illustrates the case where the point 410 is positioned inside the rectangle 450 and (B) of FIG. 5 illustrates the case where the point 410 is positioned outside the rectangle 450, and thus different control signals may be generated in (A) and (B) of FIG. 5.

FIG. 5 illustrates an example in which, when the rectangle 450 is drawn, a first touched start point 490 is positioned at a lower left part and an end point 490 and a start point 490 end equally after starting clockwise.

When the start point 490 starts from another corner of the rectangle 450 or the start point is drawn counterclockwise, a different control signal from in FIG. 5 may be generated.

In another example, a figure that is not the rectangle 450, such as a triangle, a pentagon, a hexagon, or a circle, may be drawn, a figure that is not a point may be drawn, and a plurality of points but not one point may be drawn, but when any one thereamong is changed, respective different control signals may be generated.

As such, the touch interface device 10 according to an embodiment of the present disclosure may allocate different control signals to respective numbers of numerous cases and may generate a control signal.

FIG. 6 illustrates an example in which circles are drawn on the touchscreen 110.

(A) of FIG. 6 illustrates the case where a large circle 470a is first drawn and then a small circle 470b is drawn inside the large circle 470a, and (B) of FIG. 6 illustrates the case where the small circle 470b is first drawn and then the large circle 470a is drawn to contain the small circle 470b therein.

The cases have the same attribute information including the shapes and sizes of the two figures and have the same relative position information about the figures, and accordingly, the same control signal may be generated in (A) and (B) of FIG. 6.

In another example, input order information about figures may be further included as described above, and a reference for generating a control signal may be applied.

In this case, the large circle 470a is drawn before the small circle 470b in (A) of FIG. 6, and the small circle 470b is drawn before the large circle 470a in (B) of FIG. 6, and accordingly, input order information about the two figures is different, and different control signals may be generated in (A) and (B) of FIG. 6.

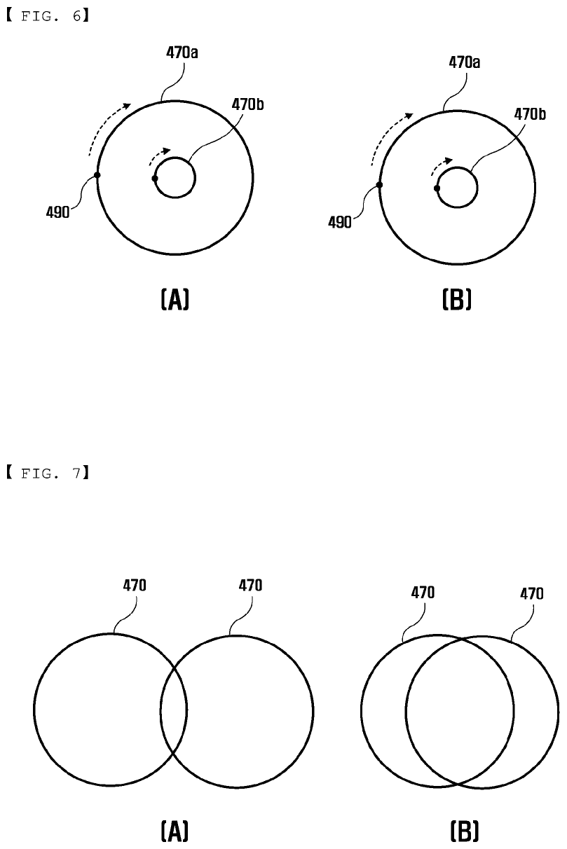

FIG. 7 illustrates an example in which circles are drawn on the touchscreen 110.

As described above for the relative position information, the relative position information may include the number of intersections at which two or more figures overlap.

Accordingly, in (A) and (B) of FIG. 7, circles 470 having similar sizes and shapes may be drawn and both the two circles 470 include two intersections, and accordingly, the same control signal may be generated.

According to another embodiment, the relative position information according to an embodiment of the present disclosure may include information on a ratio in which the two or more figures overlap, a distance between the two or more figures, and a crossing angle of the two or more figures.

When such information is included, ratios in which the two circles 470 overlap are different, distances between the two circles 470 are different, and crossing angles of the two circles 470 are different in (A) and (B) of FIG. 7, and accordingly, different control signals may be generated.

As such, depending on information included in the relative position information according to an embodiment of the present disclosure, a reference for determining a control signal may be applied in various ways.

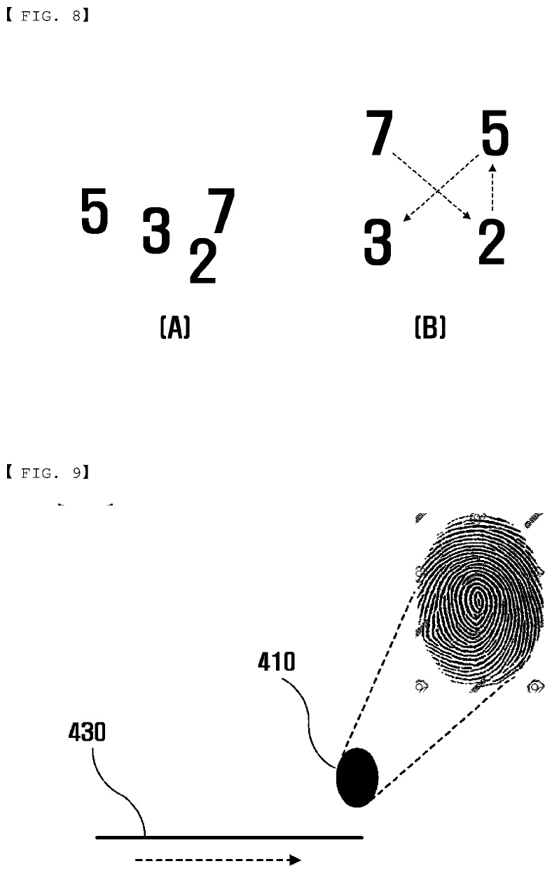

FIG. 8 is a diagram showing an example in which a figure drawn on a touchscreen according to an embodiment of the present disclosure corresponds to information on a number.

According to an embodiment of the present disclosure, when the touch interface device 10 is connected to a device having a locking function or a device including a locking device and a control signal generated by the controller 130 matches unlocking information, the touch interface device 10 may further include the unlocking unit 140 for unlocking the connected device.

The controller 130 may determine whether one figure or a figure formed by combining two continuous figures corresponds to a shape of a number among a plurality of figures touched and drawn on the touchscreen 110, and in the case of the shape of a number as the determination result, a corresponding control signal may be generated depending on the determined information on at least two numbers.

Accordingly, this means that the controller 130 determines whether one figure or a figure formed by combining two continuous figures corresponds to a shape of a number among a plurality of figures touched and drawn on the touchscreen 110, and in the case of the shape of 5, 3, 2, and 7 as the determination result, a corresponding control signal is generated, as shown in (A) of FIG. 8.

Thus, when a lock password of a specific device corresponds to “5327”, if a touch input shown in (A) of FIG. 8 is received, the controller 130 may make the unlocking unit 140 unlock the corresponding device.

This method may be applied to unlock general locking devices, locking appliances, and applications, but when greater security is required, the following method may be further applied.

When the determined information on at least two numbers, information on the order in which the numbers are drawn, and relative position information about the numbers match a preset password release condition, the controller 130 may make the unlocking unit 140 unlock the connected device.

When this method is applied, it is impossible to unlock the device simply by drawing a figure corresponding to information on a number as shown in (A) of FIG. 8.

This means that, when a figure corresponding to the shape of 7 is drawn in an upper left part, a figure corresponding to the shape of 2 is drawn in a lower right part, a figure corresponding to the shape of 5 is drawn in an upper right part, and a figure corresponding to the shape of 3 is drawn in a lower left part, the unlocking unit 140 unlocks the device, as shown in (B) of FIG. 8.

Information on numbers corresponding to “5327” needs to be input, and also, figures need to be drawn at locations corresponding to 5, 3, 2, and 7 and each number needs to be touched exactly in order, and accordingly, a higher level of security may be achieved than in (A) of FIG. 8.

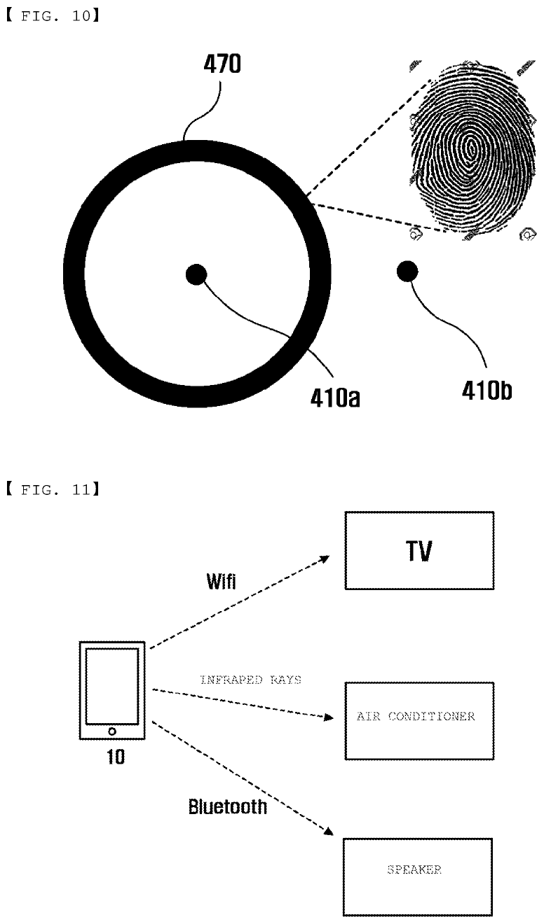

FIGS. 9 and 10 are diagrams showing examples in which user fingerprint information is recognized during a procedure of drawing a figure on the touchscreen 110 according to an embodiment of the present disclosure.

The touch interface device 10 according to an embodiment of the present disclosure may further include a fingerprint recognition unit 160 for recognizing a user fingerprint touched on the touchscreen 110.

When a control signal generated by the controller 130 matches unlocking information and the user fingerprint information recognized during the procedure of drawing a figure on the touchscreen 110 matches preregistered fingerprint information, the unlocking unit 140 may unlock the connected device.

Conventionally, in most cases, the touchscreen 110 and the fingerprint recognition unit 160 may be located separately. For example, in the case of smartphones, a home button for unlocking the device through fingerprint recognition may be provided separately from the touchscreen 110.

However, according to an embodiment of the present disclosure, a user fingerprint may be recognized through the touchscreen 110, and security may be further enhanced therethrough.

For example, a control signal generated through the controller 130 in FIG. 9 may be the same as in (A) of FIG. 2 in that the horizontal line 430 is touched and input in a rightward direction and the point 410 is touched and input in an upper right part of the horizontal line 430.

However, when the fingerprint recognition unit 160 is applied, FIG. 9 may be different from (A) of FIG. 2 in that a user fingerprint is taken when a point is touched, and accordingly, since only the control signal is the same and the unlocking information does not match, it is impossible to unlock the device.

As such, the fingerprint recognition unit 160 may not recognize the user fingerprint touched on the touchscreen 110 only when a figure corresponding to the shape of a point is drawn as shown in FIG. 9.

The unlocking unit 140 according to an embodiment of the present disclosure may use user fingerprint information recognized during a procedure of drawing a figure on the touchscreen 110, and thus when a user draws a line or a plane using all fingerprints of a finger while drawing a figure containing the line or the surface, the unlocking unit 140 may recognize the fingerprint information to unlock the unlocking unit 140.

This is exemplified in FIG. 10, and FIG. 10 shows an example in which a user draws a figure corresponding to the shape of the circle 470 on the touchscreen 110 and draws figures corresponding to the shapes of points 410a and 410b inside and outside the circle 470, respectively.

In this case, the user may draw the circle 470 using a fingerprint of a finger rather than using a touch pen or a tip of the finger when drawing a circle, and as such, the fingerprint recognition unit 160 may recognize the user fingerprint touched on the touchscreen 110.

When the figures corresponding to the shapes of the points 410a and 410b are sequentially drawn inside and outside the circle 470, respectively, the controller 130 may generate a corresponding control signal.

In this case, the unlocking unit 140 may not simply unlock the device when the control signal matches, but may unlock the connected device when the user fingerprint information recognized through the fingerprint recognition unit 160 matches the preregistered fingerprint information.

As such, even if someone knows a method of generating a control signal for unlocking the corresponding device, the device may not be unlocked if the fingerprint does not match. Thus, security may be further enhanced compared to the aforementioned methods.

In this regard, various embodiments may be applied. During a procedure of drawing a circle as shown in FIG. 10, the user fingerprint may be recognized or may also be recognized when an inside point or an outside point is drawn.

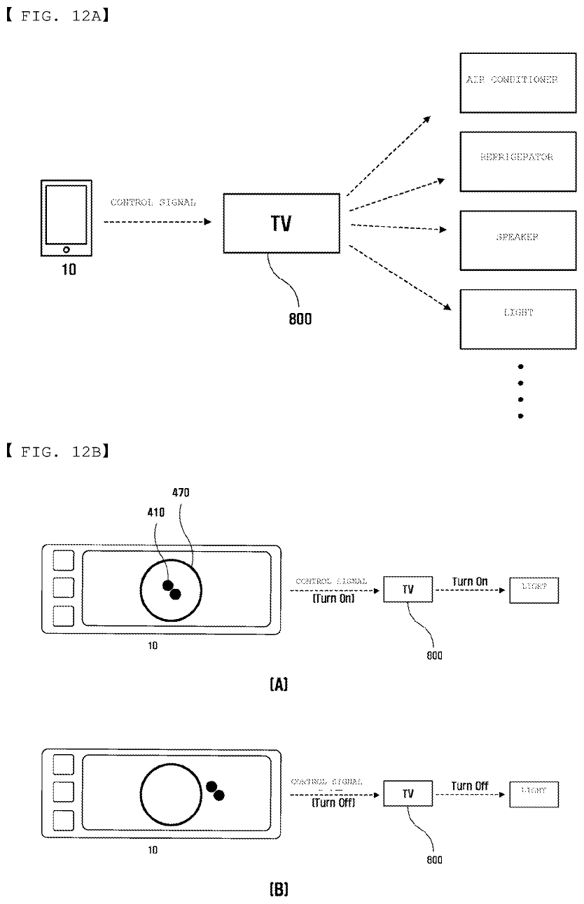

FIG. 11 is a diagram showing an example in which the wireless communication unit 150 according to an embodiment of the present disclosure changes a communication method depending on a device for receiving a control signal and transmits the control signal.

Referring to FIG. 11, the touch interface device 10 according to an embodiment of the present disclosure may further include the wireless communication unit 150 for wirelessly transmitting a control signal to a corresponding external device and controlling the corresponding external device when the control signal corresponds to an operation signal of an external device connected to the touch interface device 10.

In this case, the wireless communication unit 150 may use various communication methods such as Wi-Fi, NFC, Bluetooth, or infrared rays, may determine a method of communicating with an external device corresponding to the control signal, may convert the control signal using a corresponding communication method, and may wirelessly transmit the control signal to the external device.

Even if the touch interface device 10 is connected to various external devices and is capable of generating various control signals, when an external device that receives the control signal does not use the corresponding control signal, it may be impossible to actually use the touch interface device 10.

Accordingly, the touch interface device 10 according to an embodiment of the present disclosure may use various communication methods such as Wi-Fi, NFC, infrared rays, or Bluetooth, may convert the control signal using a communication method used by an external device that receives a control signal, and transmits the control signal, and accordingly, the touch interface device 10 may be advantageously compatible with various external devices.

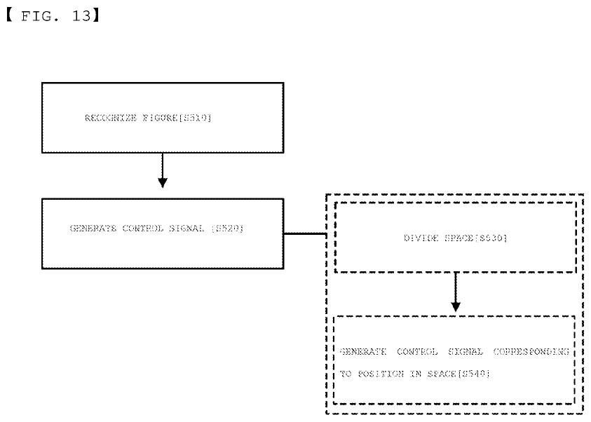

FIG. 12A is a diagram showing an example in which a control signal is transmitted to various external devices through a hub external device 800 for functioning as a hub according to an embodiment of the present disclosure. FIG. 12B is a diagram showing an example in which FIG. 12A is actually applied.

When connected to one or more other external devices and connected to the hub external device 800 for functioning as a hub, the wireless communication unit 150 according to an embodiment of the present disclosure may wirelessly transmit a control signal to the hub external device 800 and the corresponding hub external device 800 may transmit the control signal to another external device.

FIG. 12A shows an example in which the hub external device 800 is set to a TV. The TV may be connected to an external device such as an air conditioner, a refrigerator, a speaker, or a light.

Accordingly, the wireless communication unit 150 of the touch interface device 10 may transmit a control signal to the TV as the hub external device 800, and the TV may transmit the control signal to various external devices connected to the TV to control the various external devices.

(A) of FIG. 12B shows an example in which the circle 470 is drawn on a touchscreen and the two points 410 are touched and drawn inside the circle 470.

In this case, according to a preset condition, the controller 130 may generate a control signal for turning on a light and may transmit the control signal to the hub external device (TV) 800, and the hub external device (TV) 800 may transmit the control signal for turning on the light and may transmit the control signal to turn on the light.

In contrast, (B) of FIG. 12B shows an example in which the circle 470 is drawn on a touchscreen and the two points 410 are touched and drawn outside the circle 470.

In this case, according to a preset condition, the controller 130 may generate a control signal for turning off a light and may transmit the control signal to the hub external device (TV) 800, and the hub external device (TV) 800 may transmit the control signal for turning off the light to turn off the light.

As such, the controller 130 may generate a corresponding control signal and may transmit the control signal to the hub external device 800, and the hub external device 800 may transmit the corresponding control signal to the corresponding control target 900 to control the control target 900 only when a user simply inputs various patterns on the touchscreen 110 of a remote control 10, and accordingly, the various control targets 900 may be conveniently controlled.

Similarly, an air conditioner as the hub external device (TV) 800 may be turned on. When a triangle instead of a circle is drawn and two points are touched inside the triangle, the controller 130 may generate a control signal for turning on the air conditioner and may transmit the control signal to the hub external device (TV) 800, and the hub external device (TV) 800 may transmit a control signal for turning on the air conditioner to turn on the air conditioner.

In contrast, when the triangle is drawn and the two points 410 are touched outside the triangle, according to a preset condition, the controller 130 may generate a control signal for turning off the air conditioner and may transmit the control signal to the hub external device (TV) 800, and the hub external device (TV) 800 may transmit the control signal for turning off the air conditioner to turn off a light.

That is, the circle may indicate the light and the triangle may indicate the air conditioner, and in this case, a control command for different heterogeneous products may be issued using the same pattern.

FIG. 13 is a flowchart showing an example of a control method of a touch interface according to an embodiment of the present disclosure.

With reference to FIG. 13, flow of the control method of the touch interface according to an embodiment of the present disclosure will be described below.

First, the touch recognition unit 120 may recognize a figure touched and drawn on the touchscreen 110 (operation S510).

After operation S5510, based on attribute information including the shape and size of each figure recognized through the touch recognition unit 120 and relative position information about the figures, the controller 130 may generate a corresponding control signal (operation S520).

In more detail, operation S520 may further include the following operations.

When a recognized figure is a partition figure including a line or a surface, the controller 130 may divide a space on the touchscreen 110 into a plurality of spaces depending on the shape of the line or the surface (operation S530).

The controller 130 may generate a control signal corresponding to the position of a figure, which is drawn before or after the partition figures are drawn, in the plurality of spaces (operation S540).

In this case, the attribute information may include at least one of information on a direction from a first touched point to an end point when each figure is drawn, information on the thickness of a touch line for drawing each figure, information on pressure intensity of the touch line, information on touch acceleration, information on the number of broken points of the figure, or information on a time interval at which figures are input.

The relative position information may further include information on a ratio in which the two or more figures overlap, a distance between the two or more figures, and a crossing angle of the two or more figures.

According to an embodiment, the touch interface device 10 may be connected to a device having a locking function or a device including a locking device.

The method may further include unlocking the connected device by the unlocking unit 140 when the control signal generated by the controller 130 matches unlocking information.

According to an embodiment, the method may further include determining whether one figure or a figure formed by combining two continuous figures corresponds to a shape of a number among a plurality of figures touched and drawn on the touchscreen 110, by the controller 130, and in the case of the shape of a number as the determination result, generating a corresponding control signal depending on the determined information of at least two numbers, by the controller 130.

The aforementioned operation may further include unlocking a device to which the unlocking unit 140 is connected, by the controller 130, when the determined information on at least two numbers, information on the order in which the numbers are drawn, and relative position information about the numbers match a preset password release condition.

According to an embodiment, the touch interface device 10 may further include the fingerprint recognition unit 160 for recognizing a user fingerprint touched on the touchscreen 110.

The method may further include unlocking the connected device, by the unlocking unit 140, when a control signal generated by the controller 130 matches unlocking information and the user fingerprint information recognized during the procedure of drawing a figure on the touchscreen 110 matches preregistered fingerprint information.

According to an embodiment, the method may further include wirelessly transmitting a control signal to a corresponding external device and controlling the corresponding external device when the control signal corresponds to an operation signal of an external device connected to the touch interface device 10.

In this case, the wireless communication unit 150 may use various communication methods such as Wi-Fi, NFC, Bluetooth, or infrared rays, and may determine a method for communicating with an external device corresponding to the control signal, and may wirelessly transmit the control signal to the external device using the corresponding communication method.

In another example, when connected to one or more other external devices and connected to the hub external device 800 for functioning as a hub, the wireless communication unit 150 may wirelessly transmit a control signal to the hub external device 800 and the corresponding hub external device 800 may transmit the control signal to another external device

The aforementioned control method of the touch interface device 10 has the same detailed description as that of the touch interface device 10 described above with reference to FIGS. 1 to 12 while only the category of the touch interface device 10 is changed, and thus a detailed description of the control method is omitted here.

Although embodiments of the present disclosure have been described above with reference to the accompanying drawings, it would be obvious to those of ordinary skill in the art to which the present disclosure pertains that the embodiments of the present disclosure can be implemented in other specific forms without changing the technical spirit or essential features. Accordingly, it is noted that the embodiments described above are illustrative in all aspects and are non-limiting.

### DESCRIPTION OF REFERENCE NUMERALS

| | |
|---|---|
| 10: Touch interface device | 110: Touchscreen |
| 120: Touch recognition unit | 130: Controller |
| 140: Unlocking unit | 150: Wireless communication unit |
| 160: Fingerprint recognition unit | 800: Hub external device |
| 900: Control target | |

1. A touch interface device comprising:
a touch recognition unit configured to recognize a figure touched and drawn on a touchscreen; and
a controller configured to generate a corresponding control signal based on attribute information including a shape and a size of each figure recognized through the touch recognition unit and relative position information about figures,
wherein, when the recognized figure is a partition figure including a line or a surface, the controller divides a space on the touchscreen into a plurality of spaces depending on a shape of the line or the surface and generates a control signal corresponding to a position of a figure, which is drawn before or after the partition figure is drawn, in the plurality of spaces.

2. The touch interface device of claim 1, wherein the attribute information includes at least one of information on a direction from a first touched point to an end point when each figure is drawn, information on a thickness of a touch line for drawing each figure, information on pressure intensity of the touch line, information on touch acceleration, information on a number of broken points of the figure, or information on a time interval at which the figures are input.

3. The touch interface device of claim 1, wherein the relative position information includes a number of intersections at which the two or more figures overlap.

4. The touch interface device of any one of claims 1 to 3, further comprising:
an unlocking unit configured to unlock a connected device when the touch interface device is connected to a device having a locking function or a device including a locking device and the control signal generated by the controller matches unlocking information.

5. The touch interface device of claim 4, wherein the controller determines whether one figure or a figure formed by combining two continuous figures corresponds to a shape of a number among a plurality of figures touched and drawn on the touchscreen, and in a case of a shape of a number as a determination result, the controller generates a corresponding control signal depending on determined information of at least two numbers.

6. The touch interface device of claim 5, wherein the controller unlocks the connected device when the determined information on at least two numbers, information on order in which numbers are drawn, and relative position information about the numbers match a preset password release condition.

7. The touch interface device of claim 4, further comprising:
a fingerprint recognition unit configured to recognize a user fingerprint touched on the touchscreen; and
wherein the unlocking unit unlocks the connected device when a control signal generated by the controller matches unlocking information and the user fingerprint information recognized during a procedure of drawing a figure on the touchscreen matches preregistered fingerprint information.

8. The touch interface device of claim 1, further comprising:
a wireless communication unit configured to wirelessly transmit the control signal to a corresponding external device and to control the external device when the control signal corresponds to an operation signal of the external device connected to the touch interface device.

9. The touch interface device of claim 8, wherein the wireless communication unit uses at least one communication method of Wi-Fi, NFC, Bluetooth, or infrared rays, determines a method of communicating with an external device corresponding to the control signal, and wirelessly transmits the control signal using a corresponding communication method.

10. The touch interface device of claim 8 or 9, wherein, when connected to one or more other external devices and connected to the hub external device for functioning as a hub, the wireless communication unit wirelessly transmits the control signal to the hub external devices and makes the hub external device transmit the control signal to another device.

11. A method of controlling a touch interface device, the method comprising:
recognizing a figure touched and drawn on a touchscreen, by a touch recognition unit; and
generating a corresponding control signal based on attribute information including a shape and a size of each figure recognized through the touch recognition unit and relative position information about figures, by a controller,
wherein the generating the control signal includes:
when the recognized figure is a partition figure including a line or a surface, dividing a space on the touchscreen into a plurality of spaces depending on a shape of the line or the surface; and
generating a control signal corresponding to a position of a figure, which is drawn before or after the partition figure is drawn, in the plurality of spaces.
